(19) United States
(12) Patent Application Publication
(10) Pub. No.: US 2010/0192202 A1
(43) Pub. Date: Jul. 29, 2010

(54) System and Method for Implementing a Secured and Centrally Managed Virtual IP Network Over an IP Network Infrastructure

(76) Inventor: David Ker, Brossard (CA)

Correspondence Address: FAY KAPLUN & MARCIN, LLP, 150 BROADWAY, SUITE 702, NEW YORK, NY, 10038, US

(21) Appl. No.: 12/593,061

(22) PCT Filed: Mar. 26, 2008
(86) PCT No.: PCT/CA2008/000565

§ 371 Date: Mar. 18, 2010

(30) Foreign Application Priority Data
Mar. 26, 2007 (CA) 2,585,808

(51) Int. Cl. G06F 17/30; H04L 12/28

(52) U.S. Cl. 726/4; 370/395.53

(57) ABSTRACT

A method and system for establishing secure IP communication, through a virtual IP network, between at least first and second nodes comprise an access manager for validating a communication request, initiated by one of the at least first and second nodes, for communication between the at least first and second nodes. The access manager further grants at least one unique identifier to each of the at least first and second nodes upon successful validation. A channel provides for secure IP communication between the at least first and second nodes through the virtual IP network using their respective at least one unique identifier.

### FIELD

The present invention relates to communications over communication networks

More specifically, but not exclusively, the present invention relates to a method and system for providing a secured, centrally managed virtual IP network over an IP network infrastructure.

### BACKGROUND

The Internet is based on an open architecture described by the Open Standard Interface (OSI layers). The intention of the OSI layers is to allow for interworking between many different technologies, organizations, businesses and households. It is a network that requires cooperation of all the participants. It is a public network which is not owned by any companies or organizations.

In recent years, the widespread proliferation of the Internet access has brought many households, businesses and organizations to communicate and share information over the public network. Hence spam, virus, phishing are examples of unfortunate by-products that developed.

There is a need for businesses, individuals and organizations to communicate securely, privately while eliminating these undesired by-products.

Various methods have been devised for preventing these problems, or at least reducing the unwanted irritants. To reduce the amount of spam that a person receives, the following methods have been implemented: whitelisting, blacklisting, greylistings and many other methods. To provide secured communications over the Internet, methods like Firewall, VPN (Virtual Private Networks), Secure Peer to Peer networks, and Secured Network Gateway have been crafted.

Firewall is used to protect certain areas of the network from externals attacks by putting up retaining walls, which help minimize damages and exposures to external sources. Firewall enforces security at the data packet level within the IP (Internet Protocol) protocol stack. FIG. 2A provides a typically simplified data flow from Host A 1001 to Host B 1003 through Firewall 1002. Any application services that try to reach Host B 1003 must be authorized by Firewall 1002, which works in collaboration with Host B 1003. The main function of a firewall is to restrict service access to non-authorized external hosts.

A virtual private network (VPN) is a secure method of accessing a private network using a public network. A private network is composed of computers owned by a single organization that share information with each other. Typically, corporate Local Area Network (LAN) or Wide Area Network (WAN) is an example of such private networks. A VPN is basically a way to simulate a private network over a public network, such as the Internet, by way of tunnelling network traffic over a secure communication channel. FIG. 2B illustrates a conventional and simplified VPN network data flow diagram. For Host A 1101 to join the Private Corporate Network 1112, Host A 1101 first logs into VPN Gateway 1110. Gateway VPN 1110 then processes to authorize Host A 1101 based on its corporate policy. Upon successful authorization, an encrypted and secured peer to peer tunnel T1 1103 is created between Host A and Gateway VPN 1110. After the successful creation of the secure tunnel T1 1103, Host A 1101 is part of the Network 1112 and can therefore view and access elements of the corporate network 1112, defined by the corporate policy. As illustrated in FIG. 2B, as an example of a VPN model, the tunnel T1 1103 can encapsulate the communication IP packets into other secured IP packets, such as IPsec (IP security) to obtain packets IPsec+IP. Packets that progress from Host A 1101 to Host B 1111 are always going through the gateway 1110.

A Secure Network Gateway is a secure peer to peer connectivity with security features such as mutual authentication, authorization of a specific access, and end to end auditing. Basically, an authorized service can be used securely through a gateway, across an open network, to a known requester, with confidence that the security or privacy of the server's network is not compromised. FIG. 2C depicts a typical Secure Network Gateway data flow diagram. For Host A 1201 to access services provided by a Service Provider 1206, an encrypted peer to peer tunnel T1 1204 is created. To create this communication channel, two inputs are required: one from SSG1 (Secure Service Gateway) 1203, another one from SSG2 1205. SSG2 1205 authorizes Host A 1201 depending on the policy setup on SSG2 1205 by the Service Provider 1206. SSG1 1203 exchanges messages with SSG2 1205 before opening the connection to Host A 1201. As the secure peer to peer tunnel T1 1204 is created, services offered by the service provider 1206 could be accessed by Host A 1201. Service requests originating from Host A 1201 progress through the Secure Service Network 1210 by way of SSG1 1203 and SSG2 1205 to the Service Provider 1206. The secure Service Network architecture is designed to authorize access to services, such as Web Services, FTP (File Transfer Protocol), emails, etc.

A secure Peer to Peer (P2P) network is designed for sharing information. One main example of sharing information implemented on a peer to peer network is for files sharing, for example Napster. As illustrated in FIG. 2D, in a schematic view, for Peer A 1301 to access services provided by Peer B 1305, Peer A 1301 first gets the authorization provided by the Peer to Peer Server 1303. Upon successful authorization from the Peer to Peer Server 1303, a peer to peer tunnel T1 1304 is created between Peer A 1301 and Peer 1305. Service exchanges between Peer A 1301 and Peer B 1305 occur through this communication channel. Usually, this communication channel is encapsulated on top of the TCP/IP (Transport Control Protocol/Internet Protocol), as illustrated in FIG. 2D.

Conventional methods for dealing with spam include: email confirmations, email filters based on a header analysis and/or text analysis, etc. These methods can be further used in combination with blacklists, whitelists, and/or spam-tracking databases. All these methods contribute to filtering and eliminating some of the spams, but not all. Spammers seem to always find alternatives to circumvent these techniques. The root cause, so to speak, is therefore the spammer; accordingly, the only way to stop spams from propagating into the Internet is to stop spammers from sending unsolicited emails.

Although many of these individual technologies exist, no solution is sufficiently efficient at securing a communication network and providing services to efficiently stop unwanted solicitations. There is a need to overcome the above-discussed drawbacks. Accordingly, a system and method for implementing and establishing a secured, centrally managed virtual IP network on over an IP network infrastructure are sought.

### SUMMARY

More specifically, in accordance with a first aspect of the present invention, there is provided a method for establishing secure IP communication between at least first and second nodes through a virtual IP network managed by at least one central server. The method comprises: initiating, from one of the at least first and second nodes, a request to the at least one central server for communication between the at least first and second nodes; validating the request for communication between the at least first and second nodes; granting at least one unique identifier to each of the at least first and second nodes upon successful validation; and creating a secure channel for communication between the at least first and second nodes through the virtual IP network using their respective at least one unique identifier.

According to a second aspect of the present invention, there is provided a system for establishing secure IP communication between at least first and second nodes through a virtual IP network managed by at least one central server. The system comprises: means for initiating, from one of the at least first and second nodes, a request to the at least one central server for communication between the at least first and second nodes; means for validating the request for communication between the at least first and second nodes; means for granting at least one unique identifier to each of the at least first and second nodes upon successful validation; and means for creating a secure channel for communication between the at least first and second nodes through the virtual IP network using their respective at least one unique identifier.

According to a third aspect of the present invention, there is also provided a system for establishing secure IP communication between at least first and second nodes through a virtual IP network, The system comprises: an access manager for validating a request, initiated by one of the at least first and second nodes, for communication between the at least first and second nodes, the access manager further granting at least one unique identifier to each of the at least first and second nodes upon successful validation; and a channel for providing the secure IP communication between the at least first and second nodes through the virtual IP network using their respective at least one unique identifier.

The foregoing and other objects, advantages and features of the present invention will become more apparent upon reading of the following non restrictive description of illustrative embodiments thereof, given by way of example only with reference to the accompanying drawings.

### BRIEF DESCRIPTION OF THE DRAWINGS

In the appended drawings:

FIG. 1 is a block diagram of a secured, centrally managed virtual IP network according to a non-restrictive illustrative embodiment of the present invention;

FIG. 2A is a schematic diagram illustrating data flow in a conventional IP network using Firewall;

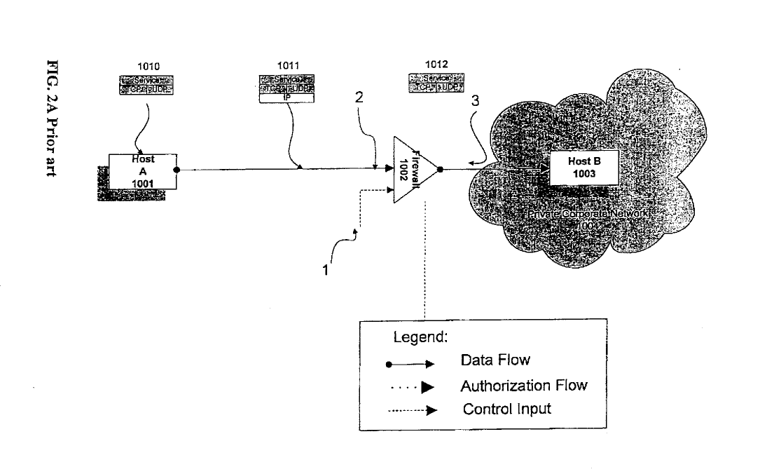

FIG. 2B is a schematic diagram illustrating data flow in a conventional VPN (Virtual Private Network);

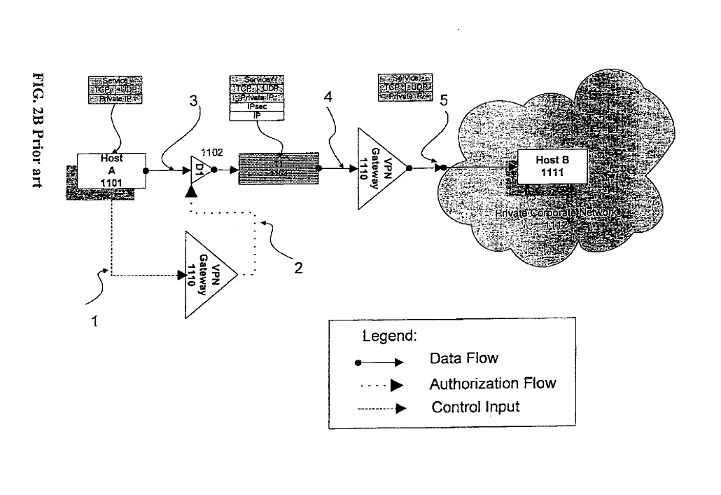

FIG. 2C is a schematic diagram illustrating data flow in a conventional Secure Service Gateway network;

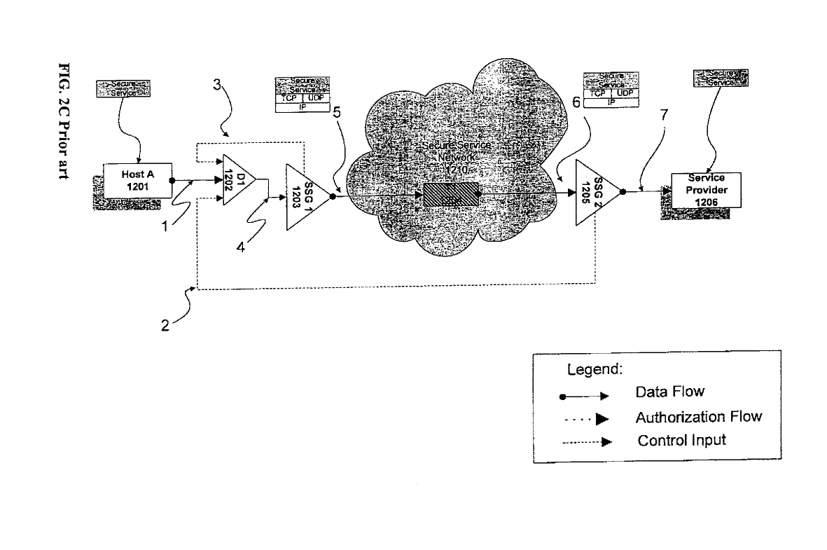

FIG. 2D is a schematic diagram illustrating data flow in a conventional Peer to Peer network;

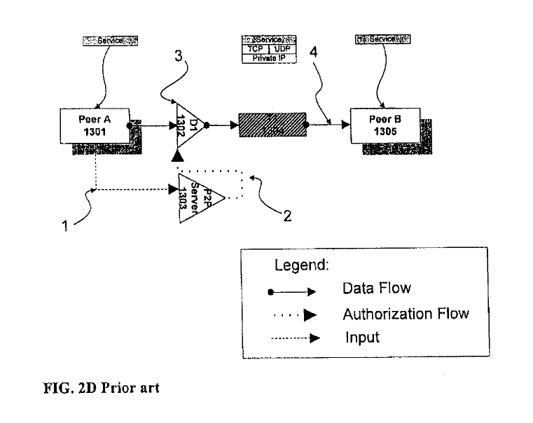

FIG. 3 is a is a schematic diagram illustrating a direct data flow from Host A to Host B, and a data flow from Host A to Host B passing through an intermediate (proxy) Host C using the virtual IP network of FIG. 1;

FIG. 4 is a schematic diagram illustrating a virtual web gateway between a virtual IP network and a real IP network;

FIG. 5 is a schematic diagram illustrating a virtual IP Node A sending emails to a virtual IP Node B through the virtual IP network of FIG. 1;

FIG. 6 is a schematic diagram of the virtual access control protocol layers and topology in an IP network infrastructure;

FIG. 7 is a schematic diagram of operations between a Node A, a VACM/VUAM (Virtual Access Control Manager/Virtual User Account Manager) and a Node D in the virtual IP network of FIG. 1;

FIG. 8 is a schematic diagram showing operations between a Node A, a Proxy B, a VACM/VUAM and a Node C, in the virtual IP network of FIG. 1;

FIG. 9 depicts a schematic flow diagram of the propagation of a VNCS (Virtual Network Connection Stamp) in the virtual IP network of FIG. 1;

FIG. 10 is a schematic diagram of a data flow through the protocol layers from a Host A to Host B through Proxy 1 and Proxy 2, in the virtual IP network of FIG. 1;

FIG. 11 is a schematic diagram of a telegram format for the VACP (Virtual Access Control Protocol) used in the virtual IP network of FIG. 1;

FIG. 12 is a schematic diagram of an access control database content maintained by the VACM/VUAM in the virtual IP network of FIG. 1; and

FIG. 13 is a flow chart of a method for establishing secure IP communications through a virtual IP network.

### DETAILED DESCRIPTION

Generally stated, a secured virtual IP network according to a non-restrictive illustrative embodiment of the present invention provides a system and method that simplify centrally managed, private and encrypted connections among diverse groups of virtual hosts over any common IP network infrastructures. Furthermore, a non-restrictive illustrative embodiment of the present invention implements and establishes a secured and centrally managed virtual IP network on a traditional IP infrastructure and enables nodes connected to the virtual IP network to communicate securely, with privacy and the ability to control the permission to communicate with each other.

Advantages of the non-restrictive illustrative embodiment of the present invention include:
discarding unsolicited communication requests from a virtual IP host, eliminating SPAMs from a user's inbox;
enabling parental control over authorized web sites which can be accessed by a child;
simplifying secure and private communications over an IP network;
supporting the currently established Internet applications and Web services without requiring the implementation of new technologies;
opening the option to create a private virtual Internet community; and
providing a mechanism to configure services that could be accessed by virtual peer hosts and enjoying a safe and secure online experience.

### Virtual IP Network

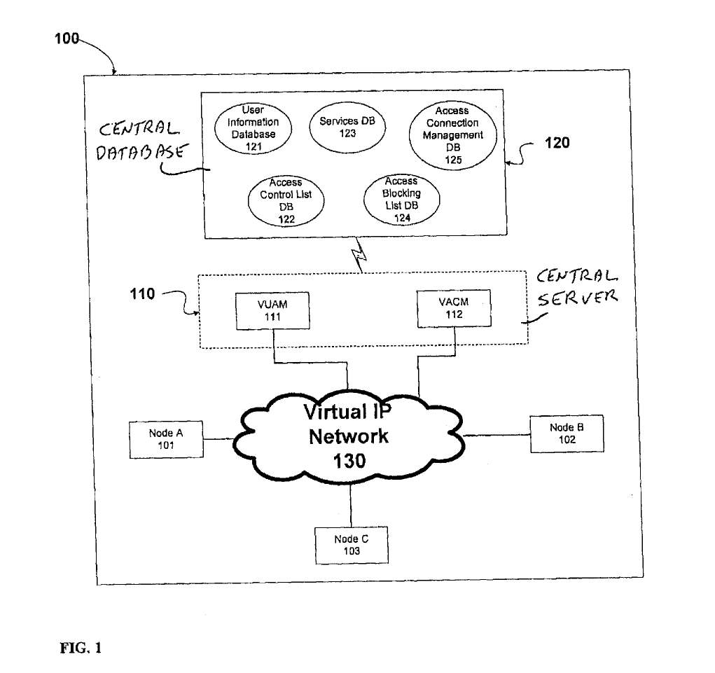

Turning now to FIG. 1, a Secured Centrally Managed Virtual IP (SCMVIP) Network 100 according to a non-restrictive illustrative embodiment of the present invention will be described, along some with conventional components suitable for implementing a virtual private network.

The SCMVIP network 100 comprises a central server 110, a central database 120 and a plurality of virtual nodes 101, 102, 103 connected to a plurality of hosts. The plurality of virtual nodes allows for a multitude of peer to peer IP connections between the virtual nodes 101, 102, and 103. This multitude of connections between the nodes 101, 102 and 103 define a virtual IP network 130. Also, it is possible that the virtual IP Network 130 be composed of dedicated IP devices, which are optimized to perform routing and forwarding of virtual access control protocol (VACP) packets within the SCMVIP network 100, for example.

The central server 110 includes a Virtual User Account Manager (VUAM) 111 and a Virtual Access Control Manager (VACM) 112.

The Virtual User Access Manager (VUAM) 111 provides the function to register users, businesses and organizations into the virtual IP SCMVIP network 100. Any node, 101, 102 or 103 should be registered within the VUAM 111 in order to benefit and access the services provided by the network 100. If they are not registered, the nodes 101, 102 and 103 can be notified of such situation and may be asked to register with the VUAM 111, which maintains a user registration in the central database 120.

Upon successful registration with the VUAM 111, a profile of the hosts connected to the nodes 101, 102 and 103 is created in the database 120. For example, a user registration is validated against valid participant references, such as credit card information, a valid address of the participant host, official certificates, governmental certificates, etc.

Then, the registered hosts can log into the central server 110 to access the virtual IP network 130. Upon successful login, the VUAM 111 allocates a Virtual User ID (VUID) for each of the hosts and transmits this VUID to the respective participant nodes (101, 102 and 103). Therefore, the participant hosts have access to the virtual IP network 130 through the nodes 101, 102 or 103. A node communicates with the network 130 using a participant VUID. A VUID uniquely identifies a registered host with the SCMVIP network 100. The VUID can be allocated only once during the registration of the host with the VUAM 111.

The Virtual Access Control Manager (VACM) 112 of the central server 110 is responsible for connection request management. For example, node 101, after having successfully logged into the central server 110, could initiate a virtual IP communication with node 102, which has also successfully logged into the central server 110; this communication could include a file transfer (FTP) transaction, a peer to peer communication, or any IP applications. To do so, node 101 makes a connection request to the Virtual Access Control Manager (VACM) 112. The connection request may contain, for example, the VUID of node 101, the virtual IP address of node 101, the virtual IP address of destination node 102 and the requested type of service. The VACM 112 could refuse or authorize the connection request from node 101 based on the information stored in the database 120.

For example, the VACM 112 can refuse the request for communication (or connection) from node 101 if the database 120 indicates that the requested service is not authorized or node 101 is not authorized to communicate with node 102.

The VACM 112 can authorize the request for communication (or connection) from node 101 if the database 102 indicates that the requested service is authorized for node 101 or that node 101 is authorized to communicate with node 102.

For example, by default it can be decided that all the services and all the participants on the nodes are authorized to access the network 130. In this case, each node (101, 102, 103) is responsible for updating the central database 120 with its own preferences and permissions. For example, when node 101 sends SPAM to node 102, node 102 could decide then to stop node 101 from sending unsolicited emails, by updating the central database 120 to block node 101. Accordingly, node 101 will be blocked from communicating with node 102 or from transmitting any emails to any node over the network 130.

More specifically, the database 120 is configured during the host's registration with the central server 110.

The central database 120 contains a User Information Database 121, an Access Control List (ACL) Database 122, an Access Services (AS) Database 123, an Access Blocking List (ABL) Database 124, and an Access Connection Management (ACM) Database 125.

The User Information Database 121 maintains and updates hosts' information and profiles, given upon their registrations. The users' information is necessary to identify each node and participant in the network 130. For example, the user information can be validated and verified for authenticity against official authorities, such as birth certificates. The user information database 121 also contains the VUID of the node, which uniquely identifies each node within the network 130. The VUID is also characterized by the mechanism used to generate it. For example, the VUID can be generated using a predefined static ID or it can be generated using a random scheme which uniquely identifies each node of the virtual IP network 130.

The Access Control List (ACL) database 122 maintains, for each node, a list of nodes which are authorized to access that node. For example, for node 102, the ACL 122 can indicate that node 101 is authorized to communicate with node 102.

The Access Blocking list database (ABL) 124 maintains, for each node, a list of nodes which are not authorized to communicate with that node.

For example, the ABL 124 of node 102 can contain node 103 which is not authorized to communicate with node 102. More specifically, node 103 may be prohibited from accessing node 102 by specifying the virtual IP address or VUID of node 103.

The service database 123 maintains users' information related to supported services for each node. The services could be characterized by supported information specified protocol, supported operation, supported data manipulation, for example. Furthermore, the service database 123 could also indicate which protocols are not authorized to be accessed, or which operations are forbidden.

Furthermore, the central database 120 can also contain registration information that describes the type of services supported and offered by a virtual web site. For example, node 103 can be a web site offering child services while node 102 offer adult online services. In this case, a parent of node 101 could update the central database 120, via the ACL database 122, to allow node 101 to access node 103 since node 103 offers services for children, while blocking access to node 102, via the ABL database 124, since node 102 offers adult services. This is done simply by indicating in the database 120 that node 101 is a child participant and that node 102 indicates services offered to adults only.

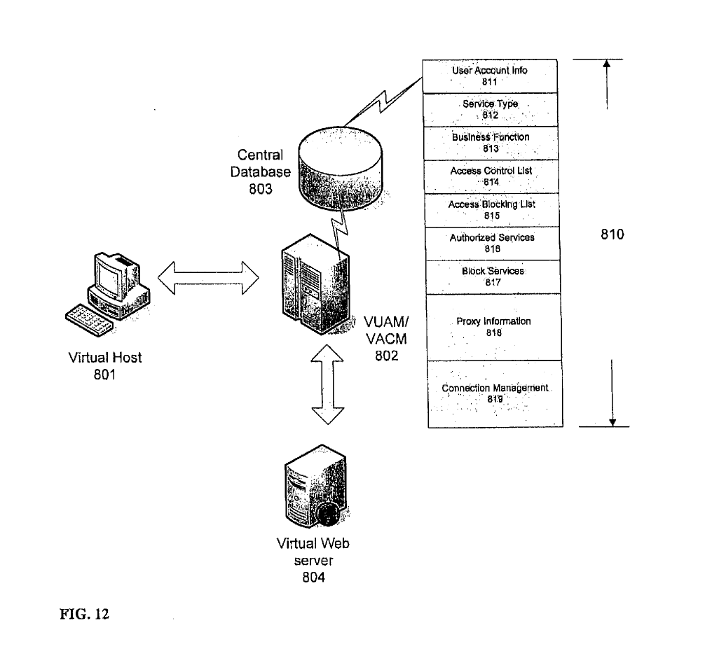

Also, the central database 120 can contain additional information as illustrated in FIG. 12. In this Figure, the database is referred to as the central database 803. The central database 803 is maintained by the VACM/VUAM of the central server 802. For example, the central database 803 could include the following elements 810:
User Account information database 811;
Service Type database 812;
Business Function database 813;
Access Control List 814;
Access Blocking List 815;
Authorized Services Database 816;
Blocking Services Database 817;
Proxy Information Database 818; and
Connection Management database 819.

These databases are maintained and managed by the VUAM and the VACM of the central server 802. The VACM mainly manages the database 819, while the VUAM manages the remaining databases.

Turning back to FIG. 1, once node 101 has been successfully authorized in the SCMVIP network 100 through the VACM 112, the VACM 112 sends to node 101: 1) its VUID, 2) its virtual IP address, 3) the virtual IP address of the destination node 102, 4) the real IP address of node 102, 5) a connection request IP, 6) a Virtual Network Connection identifier or identification of the source node 101 (source NVID), and 7) a Virtual Network Connection Identifier or identification of the destination node 102 (destination NVID).

For example, the VACM 112 can allocate two types of NVID for any node: a source NVID and a destination NVID.

A source node NVID is a unique connection communication identifier associated to a node initiating a communication, i.e. this type of NVID identifier is used to only identify the source node.

A destination node NVID is a unique connection communication identifier associated to a node, this type of NVID is used only to identify the destination node, which receives the communication from the source node.

For example, in the case where the source node 101 communicates with destination node 102, node 101 sends the source node 101 NVID and destination node 102 NVID to node 102. When node 102 responds back to node 101, node 102 transmits a source node 102 NVID and a destination node 101 NVID.

The combination of the source node NVID, destination node NVID, connection or communication request ID and destination real IP address, granted by the VACM 112, could be described as a Virtual Network Connection Stamp (VNCS). A VNCS is a digital stamp that is associated to each connection channel. For example, for a communication propagating through a series of nodes, a VNCS is allocated for each connection pair. For example, in a communication originating from node 101, passing through node 102, which, in this case, performs a role of a proxy forwarder, and terminating on node 103, one VNCS 1 is allocated for the communication channel between node 101 and node 102, and, another VNCS 2 is allocated for the communication channel between node 102 and node 103.

More specifically, the VNCS 1 can contain the request ID 1 for communication (or connection), a source node 101 NVID, a destination node 102 NVID, and the real IP address of node 102. The VNCS 2 contains the request ID 2 for communication (or connection), a source node 102 NVID, a destination node 103 NVID, and the real IP address of node 103.

Alternatively, the VACM 112 can allocate only one type of NVID, i.e. the NVID could be used interchangeably for a source node and a destination node.

It should be noted that the NVID can also correspond to the VUID of a registered node in the network 100.

Also, VUAM 111 and VACM 112 of the central server 110 can include distributed elements, so that each of the VUAM 111 and VACM 112 manages a smaller subset of the virtual IP SCMVIP network 100.

It should be noted that a plurality of central servers such as 110 can be also implemented in the virtual network 100.

Furthermore, a plurality of secured centrally managed virtual IP networks 100 could be created, each one of them dedicated to a specific organization, business, enterprise or household. Interfacing between the plurality of such networks 100 is performed by a node or a gateway. Another example could include a network 100 with a gateway or node that performs a proxy operation between the virtual IP network 100 and a real IP network, such as the Internet.

### Data Flow Through the Virtual IP Network

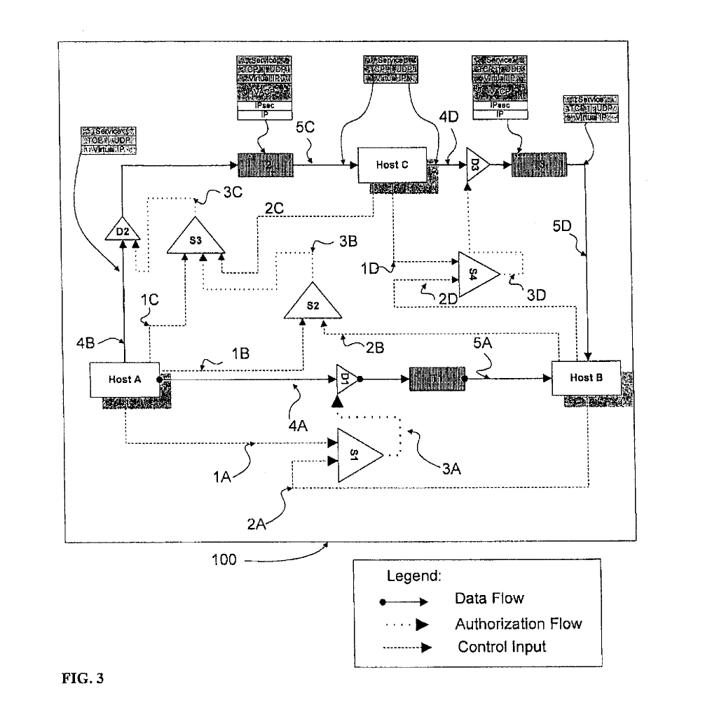

Turning now to FIG. 3, a direct data flow from Host A to Host B, and a data flow from Host A to Host B passing through an intermediate (proxy) Host C, and propagating through the virtual IP network of FIG. 1, will be described.

S1, S2, S3 and S4 as illustrated in FIG. 3 correspond to the central server 110 of FIG. 1, having a VUAM 111 and a VACM 112 for example. These servers S1, S2, S3 and S4 are used to authorize a request for communication (or connection) from Host A, B and C. Furthermore, the decision elements D1 to D3 represent the decision making performed by Host A, B and C respectively. The tunnels T1, T2 and T3 are encrypted tunnels created after successful authorization of the requests for communication (or connection) from Host A, B, or C. These tunnels represent the encapsulation of a virtual IP packet originating from a Host A, B or C into a virtual access control protocol (VACP) packet, additionally encapsulated into a real IP packet. Moreover, the encapsulation can also embed the authorizations indicated by 3A, 3B, 3C and 3D into the VACP packets so as to provide a mechanism for auditing and monitoring purposes.

For example, the encapsulation of the VACP packet could be performed over TCP (Transport Control Protocol), UDP (User Datagram Protocol), HTTP (HyperText Transfer Protocol), or any transport protocols. Furthermore, the VACP packet could be transmitted over a secured channel using any known encryption schemes such as IPsec.

Also, the tunnels could encapsulate Ethernet communications inside the VACP packets, within the virtual network 100 of FIG. 1, to allow the creation of a Virtual Local Area Network (VLAN) for example.

It should be noted that the operations required to encapsulate, de-capsulate, process VACP packets, validate VNCS, create encrypted peer to peer tunnels, etc., can be performed by a processor referred to as a Virtual IP Messenger (VIPM). A VIPM is present on each virtual IP host. Of course, a plurality of VIPM may be present as well.

The data flow originating from Host A and terminating on Host B proceeds schematically as follows:
(1) Host A initiates a virtual IP communication with Host B;
   for example, Host A can initiate a FTP connection with Host B;
(2) Host A starts sending Data 4A which progresses to D1;
(3) D1 will allow data progression to continue based on the authorization decision 3A obtained from S1; more specifically, the authorization 3A is obtained from S1 depending on the two provided inputs 1A and 2A;
   for example, when Host A makes a request for communication (or connection) to the VACM 112 of S1, the following information is provided: 1) the virtual IP address of Host A, 2) the virtual IP address of Host B, 3) the VUID of Host A, and 4) the real IP address of Host A. The server S1, through the VACM 112, looks up into its User Information database 121, ACL database 122 and ABL database 124 and checks if Host A is authorized to connect with Host B. If Host A is authorized, then S1 generates a VNCS 1, corresponding to the authorization 3A, containing the following elements: 1) the connection request ID, 2) the source NVID, 3) the destination NVID, and 4) the real IP address of the destination. The VNCS 1 is stored in the central server database 120 and is transmitted back from S1 to Host A.
(4) Upon successful authorization 3A of Host A, an encrypted peer to peer tunnel T1 is created and authorization 3A is embedded into the data 4A;
   for example, the peer to peer tunnel T1 uses TCP, UDP or any other transport protocols over a secured channel. The mechanism for establishing this tunnel in a real IP network requires that Host A examines the content of VNCS 1 so as to extract the real IP address of destination Host B for establishing the peer to peer tunnel in the real IP network with a real IP address of Host B.
(5) Data 4A progresses through T1 to become 5A and terminate on Host B;
   Host A transmits virtual IP communication data 4A over the peer to peer tunnel. This process is handled by a processor or a program executing on Host A, such as VIPM, which encapsulates the virtual IP packets over the VACP packets. Each VACP packet contains the VACP header information in addition to the authorization 3A, also defined as VNCS 1.
(6) Host B then extracts 3A from data 5A; after successful verification, data 5A is processed;
   more specifically, when Host B receives a VACP packet contained in data 5A from Host A, it extracts the VNCS 1 and validates the VNCS 1 in collaboration with S1 or using the algorithm that was used by S1 to generate the VNCSs. If the VNCS 1 is valid, the virtual IP packet is de-capsulated from the VACP packet. If the VNCS 1 is invalid, the virtual IP packet is dropped. Also, when the VNCS 1 of the first received packet is valid, the first packet is stored into a temporary buffer of Host B. Future packets received by Host B from Host A with the same VNCS 1 are declared valid without further processing or validation.

It should be noted that the authorization 3A corresponds to the virtual network connection stamp (VNCS), which is further described as a combination of identifiers as mentioned hereinabove. In one approach, to minimize the impact on the performance due to the potential large number of transactions with S1, Host B and S1 use the same algorithm to generate the authorization 3A, for example. In another approach, Host B can also perform a validation of the authorization 3A with S1 to ensure that 3A is not forged or corrupted. This solution ensures validity of the authorization 3A; however additional transactions between Host B and the central server S1 occur in this case.

Referring to FIG. 3, a schematic data flow originating from Host A and terminating on Host B, passing through Host C can proceed as follows:
a) Host A initiates a virtual IP communication with Host B;
b) Data 4B originating from Host A progresses to D2;
c) D2 will allow data progression to continue based on the authorization 3C obtained from S3, where 3C is obtained from S3 conditional to the three provided inputs 1C, 2C and 3B; moreover authorization 3B is obtained from S2 conditional to the provided inputs 1B, 2B;
d) Upon successful authorizations of 3B and 3C, an encrypted peer to peer tunnel T2 is created between Host A and Host C;
e) Data 4B progresses through T2 to become 5C and terminates on Host C with the authorizations 3B and 3C embedded into data 5C;
f) Upon receiving data 5C, Host C extracts the authorizations 3B and 3C from data 5C, and performs verification of authorization 3C;
g) Upon successful verification of 3C, Host C processes data 5C;
h) Data 5C is to be forwarded to Host B, so Host C initiates a virtual IP communication with Host B;
i) Data 5C is forwarded into data 4D, which progresses to D3;
j) D3 will allow data 4D progression to continue based on authorization 3D obtained from S4, where 3D is obtained from S4 conditional to inputs 1D (from Host C) and 2D (from Host B);
k) Upon successful authorization of 3D, an encrypted peer to per tunnel T3 is created;
l) Data 4D progresses through T3 to become 5D and terminates on Host B with the authorizations 3B, 3C and 3D embedded into the data 5D;
m) Upon receiving data 5D, Host B extracts 3B, 3C, 3D from data 5D, and performs verification of 3B; and
n) Upon successful verification of 3B, Host B processes data 5D.

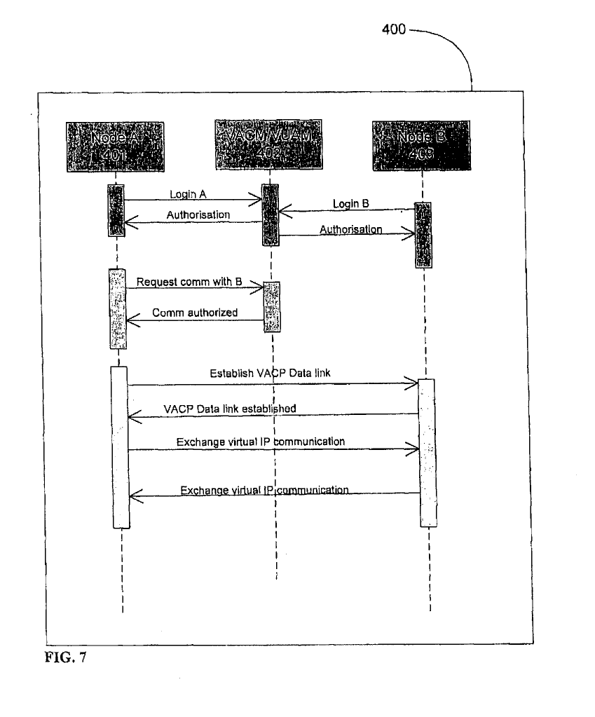

Furthermore, FIG. 7 illustrates another example of interactions in a virtual IP network 400, between a node A 401, a VACM/VUAM of a central server 402 and a node B 403 in the form of a sequence diagram, at the VACP level.

Interactions and sequence of operations in the virtual IP network 400 can be described as follows:
1. Node A 401 performs a login operation into the VACM/VUAM of the central server 402;
2. Node B 403 also performs a login operation into the central server 402;
3. The central server 402 authorizes the login operation from Node A 401, assuming that Node A 401 has already created an account on the central server 402;
4. The central server 402 also authorizes the login operation from Node B 403, with the assumption that Node B 403 has also already created an account on the central server 402;
5. Node A 401 makes a request for communication (or connection) to the central server 402, indicating Node B 403 as the target destination;
6. The central server 402 authorizes the connection request;
7. Node A 401 then establishes a peer to peer link with Node B 403 through a VACP data link;
8. Node B 403 acknowledges, and the VACP data link is created;
9. Node A 401 starts exchanging virtual IP communication data with Node B 403; and
10. Node B 403 starts also exchanging virtual IP communication data with Node A 401.

In this example, the validation of the VNCSs has not been illustrated for simplification purposes. It is assumed that the VNCSs are distributed and each component of the virtual network performs the appropriate validation of the VNCSs before authorizing any request for communication (or connection).

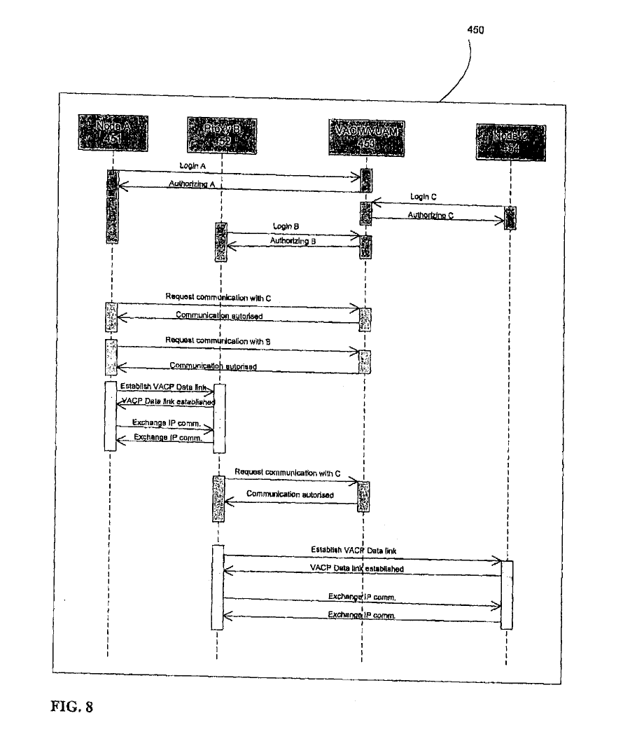

FIG. 8 also illustrates the interactions within a virtual IP network, between two nodes using the services of a proxy. Indeed, the virtual IP communication network 450 includes network components such as Node A 451, proxy B 452, a VACM/VUAM of a central server 453 and a Node C 454.

The use of a proxy server allows for performing the forwarding operation. In this example, the nodes 451, 452 and 454 are assumed to have a valid user account in the virtual IP network 450.

Interactions and sequence of operations in the virtual IP network 450 can be described as follows:
a) Node A 451 performs a login operation into the server 453;
b) The server 453 then authorizes Node A 451 into the virtual IP network 450;
c) Node C 454 performs a login operation into the server 453;
d) The server 453 authorizes Node C 454 into the virtual IP network 450;
e) Node B 452 performs a login operation into the server 453;
f) The server 453 authorizes Node B 452 into the virtual IP network 450;
g) Node A 451 performs a request for communication (or connection) to the server 453, indicating Node C 454 as the destination;
h) The server 453 authorizes the request for communication (or connection) after looking into its database;
i) Node A 451 performs a request for communication (or connection) to the server 453, indicating proxy B 452 as the destination;
j) The server 453 authorizes the request for communication (or connection) after looking up into its database;
k) After the authorization, Node A 451 establishes a VACP data link with the proxy server 452 (Node B);
l) The proxy server 452 (Node B) accepts the request for communication (or connection);
m) Node A 451 transmits data to the proxy 452;
n) The proxy 452 (Node B) acknowledges data reception from Node A 451;
o) The proxy 452 (Node B) makes a request for communication (or connection) to the server 453, indicating Node C 454 as the destination;
p) The server 453 authorizes the request for communication (or connection);
q) The proxy 452 (Node B) establishes a VACP data link with Node C 454;
r) Node C 454 accepts the connection;
s) The proxy 452 (Node B) forwards the data received from Node A 451 to Node C 454; and
t) Node C 454 acknowledges data reception.

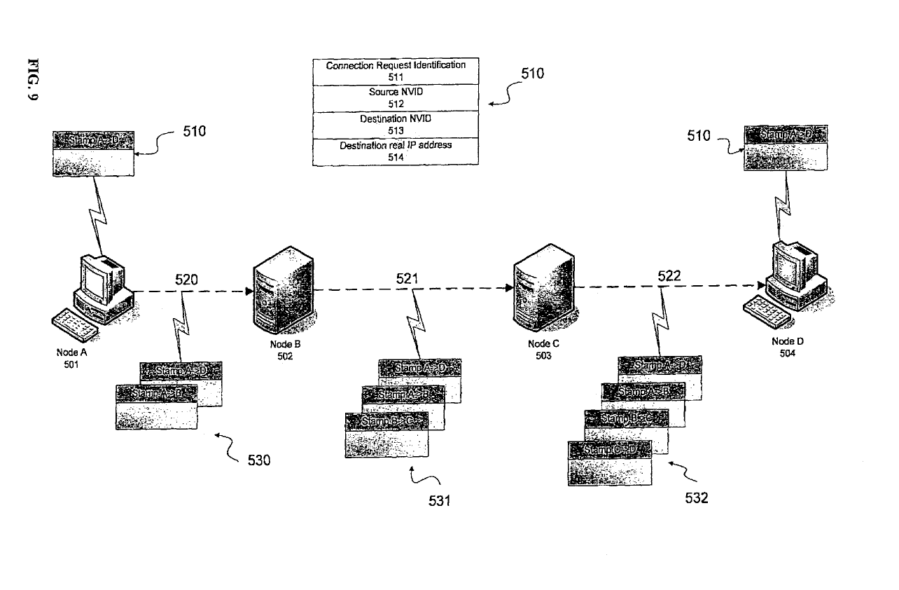

Now more specifically, with reference to FIG. 9, a flow diagram of the propagation of a Virtual Network Connection Stamp (VNCS) 510 from Node A 501 to destination Node D 504, in a virtual IP network, will be described.

It should be noted that VNCS 510 can be used to trace the path of communication exchanges between different nodes within a virtual IP network. For example, the VNCS 510 can include the following fields: 1) a connection request identification 511, 2) a source NVID 512, 3) a destination NVID 513 and 4) a destination real IP address 514. The VNCS 510 can further include a time stamp field and/or any other relevant information.

Node A 501 is assumed to be the initiator of the communication between Node A 501 and Node D 504. To initiate the communication in the virtual IP network, Node A transmits the VNCS 510 to node D 504, by providing enough information for Node D 504 to be able to authorize the connection. As illustrated in FIG. 9, Node A 501 transmits through the channel 520 two VNCSs: a VNCS for the connection A-D and a VNCS for the connection A-B. Node B 502 receives the two VNCSs, adds a third VNCS for the connection B-C and then propagates the three VNCSs through the channel 521 to Node C 503. Node C 503 receives the three VNCSs from Node B 502 and then adds its own VNCS for the connection C-D. Next, Node C 503 forwards the four VNCSs through the channel 522 to Node D. Node D 504 receives all the 4 VNCSs: VNCS C-D, VNCS B-C, VNCS A-B and VNCS A-D. However, Node D 504 is interested only in VNCS A-D and VNCS C-D which will be then validated. If these VNCS C-D and A-D are not validated, i.e. not authorized, all incoming virtual IP packets will be discarded. Furthermore, any VNCS received by each node could be accumulated in each node for monitoring and auditing purposes.

### Gateway

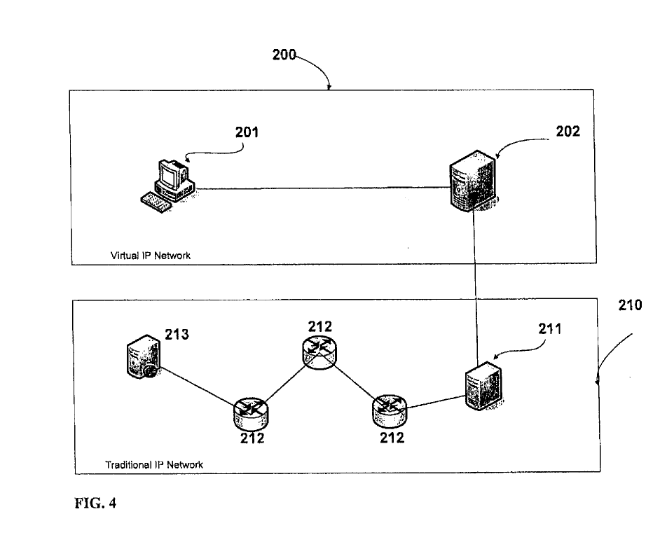

In another non-restrictive illustrative embodiment of the present invention, the concept of gateway between a virtual IP network 200 and a real IP network 210 could be implemented, as shown in FIG. 4.

For example, a participant host 201 desires to access the web server 213 within the real IP network 210. The participant host 201 could do so through a server 202. The server 202 performs the NAT (Network Address Translation) operation necessary to forward virtual IP packets from the participant host 201 to a server 211. It should be noted that the servers 202 and 211 could be viewed as the same server, with one interface interacting with the virtual IP network 200 and another interface interacting with the real IP network 210. Elements 212 can represent routers in a traditional IP network infrastructure.

### Application Examples

An example of applications of virtual IP communication between two nodes may include a virtual IP Node A sending emails to a virtual IP node B. Generally, the email exchanges pass through an email transmit server P1, such as a SMTP (Simple Mail Transfer Protocol) server and through an email receiver server P2, such as a POP (Post Office Protocol) server. Also, the communication exchanges are performed in collaboration with a virtual access control manager (VACM), as will be explained hereinbelow.

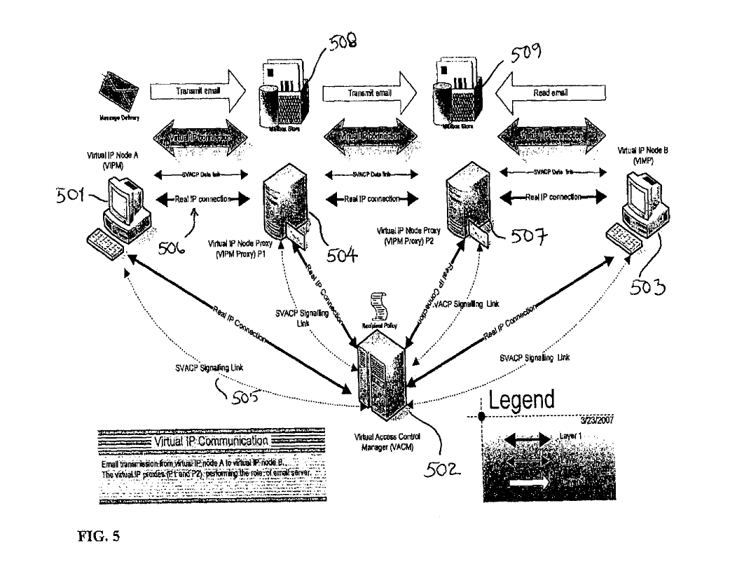

FIG. 5 provides such an example of electronic mail transactions performed within a virtual IP network. For illustrations purposes, two virtual IP hosts, Node A and Node B, two proxy servers P1 and P2, an electronic mail sender server, one electronic mail receiver server and a central server having a VACM and database are provided. It should be noted that when Node A sends an electronic mail to Node B through the virtual IP network, this electronic mail transaction can be substantially similar to any electronic mail transactions on a traditional IP network infrastructure.

The electronic mail (email) transaction can be described as in the following steps:
(1) The electronic mail is transmitted from Node A to mail server P1, using the SMTP protocol; P1 is the mail server agent responsible for buffering and transmitting all electronic mails from its client, i.e. node A;
(2) P1 receives the email;
(3) P1 sends the email to the email received server P2;
(4) P2 receives the email, stores it in the inbox for its client Node B; and
(5) Node B checks for new emails in the inbox and then extracts the new email from Node A using the POP protocol, for example.

The above procedure may seem simple at the virtual IP network layer, corresponding to Layer 1 in FIG. 5. However, at the Virtual Access Control Protocol (VACP) network layer, corresponding to Layer 2, the procedure is more complex due to the involvement of the VACM of the central server.

More specifically, in Step (1), the email transmission request made by Node A 501, using the VIPM of Node A 501 for example, triggers two requests C1 and C2 (not shown) for communication (or connection) from Node A 501 to the VACM 502 of the central server. The request C1 for communication (or connection) contains: 1) the VUID of Node A 501, 2) the virtual IP address of Node A 501, 3) the virtual IP address of Node B 503, and 4) the real IP address of Node A 501. The second request C2 for communication (or connection) contains: 1) the participant VUID of Node A 501, 2) the virtual IP address of Node A 501, 3) the virtual IP address of proxy P1 504, and 4) the real IP address of Node A 501.

The VACM 502 authorizes Node A 501 to communicate with Node B 503 depending on the configuration stored in the database (not shown) of the central server. If Node B 503 configures the central server database to authorize this communication, then, the VACM 502 authorizes the request for communication (or connection). Upon successful authorization, the VACM 502 creates a VNCS A (not shown) for this connection. The VNCS A contains: 1) a connection request identifier, which uniquely identifies the communication between Node A 501 and Node B 503, 2) a source NVID, which uniquely identifies Node A 501, 3) a destination NVID, which uniquely identifies Node B 503, and 4) a real IP address of Node B 503.

Similarly, the VACM 502 also authorizes Node A 501 to communicate with proxy P1 504 depending on the configuration stored in the central server. Upon successful authorization, the VACM 502 creates a VNCS B (not shown) for this connection or communication. The VNCS B contains: 1) a connection request identifier, which uniquely identifies the communication between Node A 501 and P1 504, 2) a source NVID, which uniquely identifies Node A 501, 3) a destination NVID, which uniquely identifies P1 504, and 4) a real IP address of proxy P1 504.

The VNCS A and B are stored into the central server database (not shown) and are transmitted to Node A 501. As depicted in FIG. 5, Node A 501 then establishes a SVACP supervision or signalling VACP link 505 between Node A 501 and the VACM 502 of the central server for exchanges of connection or communication request information. This supervision link 505 could be a link transmitted over TCP, UDP, or any other transport protocols. This link 505 could also be secured using known encryption mechanisms. A SVACP supervision link 505 can be also used for transmitting the VNCS A and B from the VACM 502 to Node A 501.

After Node A 501 receives the connection or communication authorization, Node A 501 establishes an encrypted peer to peer link 506 with the transmit email agent P1 504. Then, the VNCS A and B are transmitted to P1 504 from Node A 501 using the peer to peer link 506. Once the VNCS are received, P1 504 validates the VNCS B. Upon successful validation, all the virtual IP packets, coming from Node A 501, are processed, with each packet containing the VNCS A and B. Node A 501 continues to transmit the email message to P1 504 until completion.

In step (2), P1 504 stores the received email message in a storage medium 508. The storage 508 for emails includes the email message with the addition of the VNCS A and VNCS B. Also alternatively, the VIPM, implemented in P1 for example, is responsible for the storage of the VNCS A and B. It is noted that the VIPM should be in this case implemented to support electronic mail protocol and be able to associate a VNCS within an email message.

In step (3), P1 504 processes the stored email message, which will be sent to proxy P2 507. To do so, a request C3 (not shown) for communication (or connection) between P1 504 and the VACM 502 of the central server is initiated by P1 504. Indeed, P1 504 sends to the VACM 502 the request for communication (or connection) containing 1) the participant VUID of P1 504, 2) the virtual IP address of P1 504, 3) the virtual IP address of proxy P2 507, and 4) the real IP address of P1 504. Upon reception, the VACM 502 authorizes the request for communication (or connection) and sends back the VNCS C containing 1) a connection request identifier, which uniquely identifies the communication between P1 504 and proxy P2 507, 2) a source NVID, uniquely identifying P1 504, 3) a destination NVID, uniquely identifying P2 507, and 4) a real IP address of P2 507. Once the VNCS C has been received, P1 504 establishes a peer to peer link with P2 507, based on the destination email address. Also, the VIPM of P1 504 extracts the VNCS A and VNCS B from the received email message and then transmits the extracted VNCS A and VNCS B and the VNCS C to P2 507. Once P2 507 receives the three VNCSs, P2 507 validates the VNCS C and VNCS A on behalf of its client and authorizes the email reception process. Then P1 504 transmits the rest of the email message to P2 507 until completion.

In step (4), P2 507 stores the complete received email message into the client's inbox 509. P2 507 could also store the VNCS A, B and C for monitoring and auditing purposes.

In step (5), the host connected to Node B 503 checks for emails in the inbox 509. This operation triggers a request C4 (not shown) for communication (or connection) from Node B 503 to the VACM 502. The connection or communication request C4 contains 1) the VUID of Node B 503, 2) the virtual IP address of Node B 503, 3) the virtual IP address of P1 504, and 4) the real IP address of Node B 503. The VACM 502 checks and authorizes the request C4 for communication (or connection) against its central database. Upon successful validation and authorization, the VACM 502 sends back the VNCS D (not shown) to Node B 503. The VNCS D contains 1) a connection request identifier, uniquely identifying the communication between Node B 503 and P2 507, 2) a source NVID, uniquely identifying Node B 503, 3) a destination NVID, uniquely identifying P2 507, and 4) a real IP address of P2 507. Once Node B receives the VNCS D, Node B 503 establishes a peer to peer tunnel (not shown) with P2 507. Node B 503 also transmits the VNCS D to P2 507 for verification. P2 507 verifies the VNCS D and then authorizes the communication. Finally, Node B 503 extracts the email message from P2 507.

### Protocol Layers

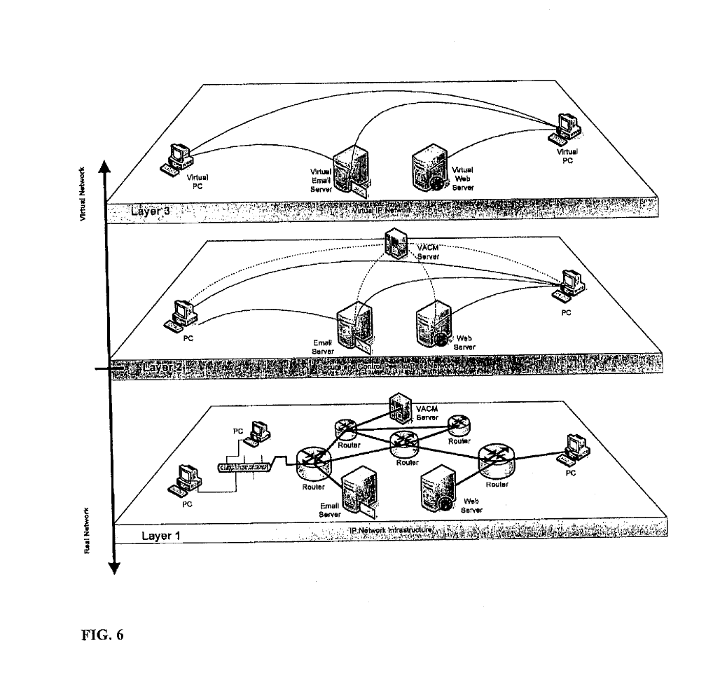

Now turning to FIG. 6, the different layers of the virtual access control protocol (VACP) and their topology used in the virtual IP network such as 100 of FIG. 1, for sending emails, for example, will be described.

Generally, the virtual IP network 100 runs over the traditional IP network. Layer 1 as shown in FIG. 6 corresponds to a public IP network similar to any public network, with a local/wide area network LAN/WAN, routers and IP hosts, for example.

Layer 2 is the secured VACP network layer. It provides a secured peer to peer connection between virtual hosts and enables virtual IP hosts to communicate securely, privately over a virtual IP network. It provides also the ability to manage this communication, to authorize participant hosts to enter into communication with a node, to indicate which services are supported by a host, to forbid participant hosts to communicate with a node, etc.

Layer 3 is the established virtual IP network 100. In this network layer, applications and services are executed and processed similarly to any traditional IP network. The difference is characterized by the IP address of each host, which represents a virtual IP address, thus not reachable from a real IP network. Also, the routers are absent in the virtual IP network. Furthermore, the virtual IP network could be viewed as a closed virtual Internet where the participant hosts are protected from the outside world and could communicate with each other securely with control over access and communication permissions.

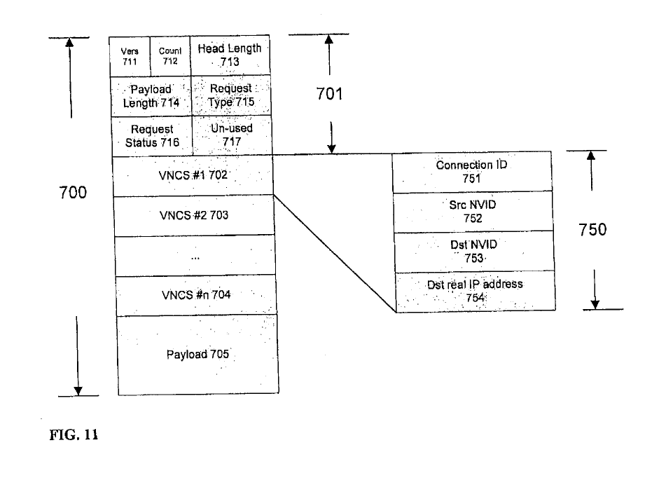

It should be noted that a telegram format can be used in the description of the Virtual Access Control Protocol (VACP). Turning to FIG. 11, such a telegram format for the VACP will be described.

The VACP telegram 700 includes a VACP header 701, a plurality of VNCSs (702, 703, 704) and the payload 705.

The telegram header 701 includes the following fields:
Version 711: indicates the current version of the VACP protocol;
Count 712: indicates the number of VNCS elements contained in the VACP telegram;
Header Length 713 : indicates the length of the VACP telegram header;
Payload Length 714: indicates the length of the payload 705, i.e. the virtual IP data packets;
Request Type 715: indicates the requested type of operation, for example, get, set, etc.;
Request Status 716: indicates the status of the request operation; and
Un-used 717: indicates a field available for future use.

Each of the plurality of the VNCS 702-704 describes a virtual network connection stamp allocated to each connection channel. Each VNCS includes:
Connection ID 751;
Source NVID 752;
Destination NVID 753; and
Destination real IP Address 754.

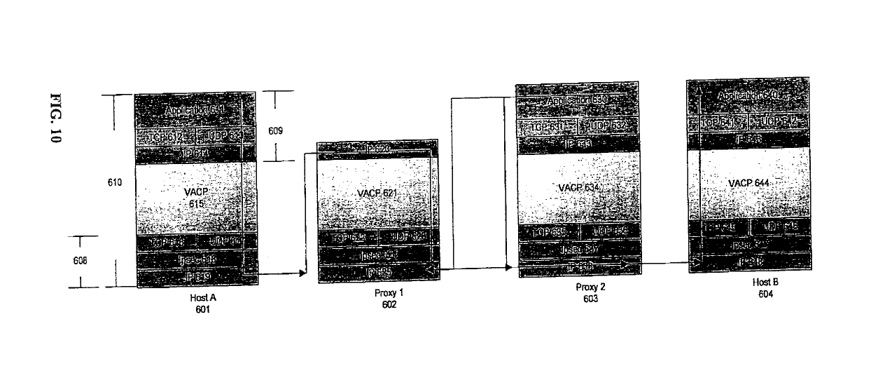

Now turning to FIG. 10, a flow diagram illustrating packet transmission through the different protocol layers from Host A to Host B through Proxy 1 and Proxy 2 will be described. Generally, a common technique used to provide data privacy and data integrity in a secured communication session is the IPsec encryption and authentication. Of course, other tunnelling techniques may be used as well.

The module 601 represents the protocol stack 610 framework of Host A, which is formed of a plurality of layers. The module 601 includes an application service layer 611, which sits on top of the TCP layer 612 and the UDP layer 613. The TCP 612 and UDP 613 layers sit on top of the IP layer 614. The application service layer 611 could include any application protocols such as FTP, HTTP, SNMP (Simple Network Management Protocol), Instant Messaging, SMTP, POP, etc. The application service layer 611, the TCP layer 612, the UDP layer 613 and the IP layer 614 form the set of layers 609. These layers sit on top of the VACP layer 615. The VACP layer 615 corresponds to a secured control protocol stack. For example, this layer handles peer to peer tunnelling, connection management on behalf of a higher layer, etc. The VACP layer 615 itself lies on top of another set of layers 608. The set of layers 608 includes the TCP layer 616 and UDP layer 617, the IPsec layer 618 and the IP layer 619. As shown in FIG. 10 by an arrow, data originating from the application service layer 611 progresses through all the layers of the protocol stack 610 before reaching Proxy 1.

The module 602 illustrates a protocol stack of Proxy 1 performing forwarding of the received virtual IP packets from Host A. The module 602 is the simplest form of a proxy virtual host. For example, the module 602 handles the data packets only at the IP layer 620. All virtual IP packets received by Proxy 1 are forwarded to the next host, Proxy 2.

The module 603 illustrates a complex virtual IP host protocol stack, for Proxy 2. Proxy 2 performs forwarding of the virtual IP packets, received from Proxy 1 and based at the application service layer 630. It stores the received application service data into its storage medium before transmitting them to the next Host B. The received packets from Proxy 1 are analyzed in collaboration with VIPM from layers 630 to 633, which correspond to the application, TCP, UDP and IP layers respectively. This analysis allows for mapping the application services with the VACP layer 634 in such a way that the communication at the application layer 630 are linked to the communication at the VACP layer 634.

Finally, the module 604 illustrates the stack of protocols of the virtual Host B on which the communication channel is terminated. The module 604 is similar to the stack 601. As illustrated in FIG. 10, data is originated from Host A through the module 601, progresses to Proxy 1 through module 602 and to Proxy 2 through module 603, and terminates on Host B through module 604. This data progression traverses all the protocol layers as illustrated in FIG. 10.

### Method of Establishing a Secured and Centrally Managed Virtual IP

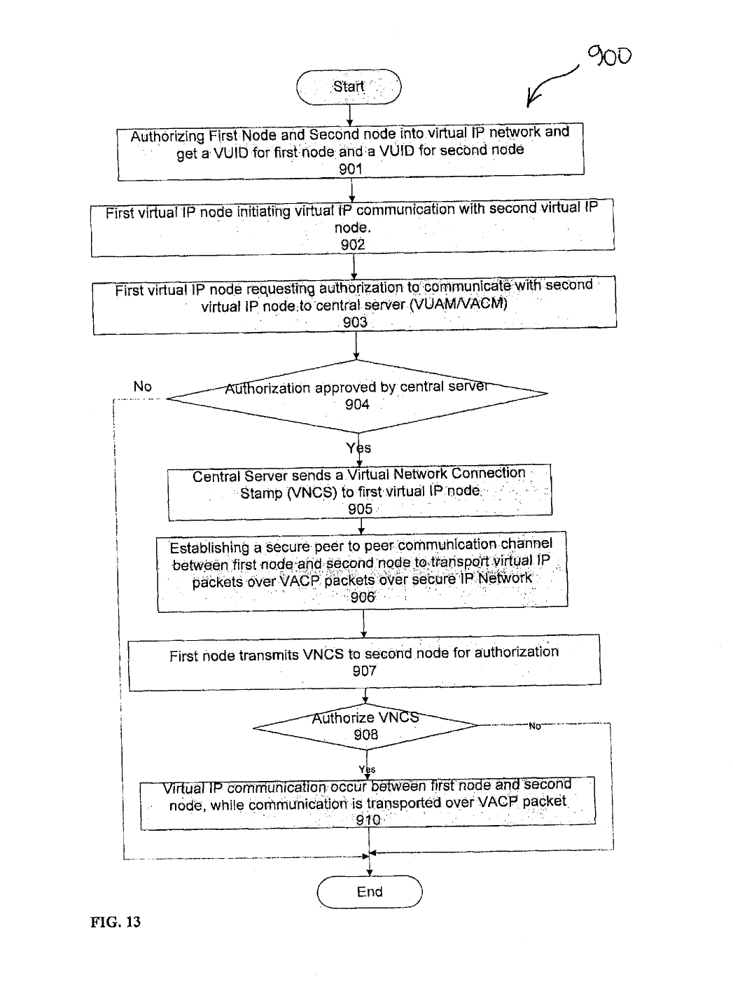

Finally, turning to FIG. 13, a method 900 for establishing a secured and centrally managed virtual IP network for communications between a first and a second nodes will be described with reference to FIG. 1.

The method 900 assumes that the first and second nodes have already an account created on the central server 110 through the VUAM 111. therefore, they correspond to a first and second virtual IP nodes.

In step 901, the first virtual IP node and the second virtual IP node are authorized into the virtual IP network 100 and are then granted with a unique VUID for each node.

In step 902, the first virtual IP node can start initiating a communication with the second virtual IP node. For example, the virtual network 100 can be a virtual local area network (Virtual LAN), in this case, the VACP protocol stack encapsulates the Ethernet packets over the VACP packets.

When initiating the communication, in step 903 the first virtual IP node first sends a request to the central server VUAM/VACM 110 for authorization to communicate with the second virtual IP node.

In step 904, if the central server 110 refuses to grant the authorization to communicate between the first and second virtual IP nodes, then method 900 ends. On the contrary, if the authorization is successfully granted, method 900 proceeds with step 905.

In step 905, the central server 110 allocates a virtual network connection stamp (VNCS) for the communication channel between the first virtual IP node and the second virtual IP node, and then transmits the VNCS to the first virtual IP node.

In step 906, upon receiving the VNCS from the central server 110, the first virtual IP node establishes a secure peer to peer tunnel with the second virtual IP node.

Then, in step 907, the first virtual IP node transmits the VNCS to the second virtual IP node for verification and validation. In another example, this step is not implemented; instead the VNCS is simply embedded into the VACP packet.

In step 908, the second virtual IP node receives the VNCS from the first virtual IP node, verifies and validates the received VNCS in collaboration with the central server 110. If the validation fails, the communication exchanges through the peer to peer tunnel are discarded and method 900 ends. If the validation is successful, method 900 proceeds to the following step.

Finally, in step 910, the virtual IP transactions between the first virtual IP node and the second virtual IP node occur through the peer to peer tunnel. The virtual IP packets exchanged between the first virtual IP node and the second virtual IP node are encapsulated over the VACP packets.

Generally stated, the method 900 and system 100 according to a non-restrictive illustrative embodiment of the present invention provides secure virtual IP communications (peer to peer communications) between a first virtual IP node and a second virtual IP node, while maintaining privacy over the Internet. The method 900 and system 100 allow a virtual IP node to access a virtual access control manager (VACM) and to configure the database of the VACM so as to authorize or forbid access to services or to a specific virtual host. Furthermore, the propagation of the virtual network connection stamp (VNCS) within a communication channel provides a procedure to trace and audit communication exchanges between a first node and a second within the virtual IP network. In this way, it is apparent that problems related to un-authorized communications can be stopped while securing and maintaining privacy of a virtual IP communication channel.

It should be understood that even though the Virtual IP network was described in a context of an IP network, the present can be also used in other kinds of networks, which are within the scope and nature of the present invention.

Although the present invention has been described in the foregoing specification by means of a non-restrictive illustrative embodiment, this illustrative embodiment can be modified at will within the scope of the appended claims without departing from the spirit and nature of the subject invention.

What is claimed is:

1. A method for establishing secure IP communication between at least first and second nodes through a virtual IP network managed by at least one central server, the method comprising:
initiating, from one of the at least first and second nodes, a request to the at least one central server for communication between the at least first and second nodes;
validating the request for communication between the at least first and second nodes;
granting at least one unique identifier to each of the at least first and second nodes upon successful validation; and
creating a secure channel for communication between the at least first and second nodes through the virtual IP network using their respective at least one unique identifier.

2. A method for establishing secure IP communication as defined in claim 1, further comprising authorizing the at least first and second nodes into the virtual IP network for communication between said at least first and second nodes.

3. A method for establishing secure IP communication as defined in claim 2, wherein authorizing the at least first and second nodes into the virtual IP network comprises creating a user account for each of the at least first and second nodes in a database of the at least one central server.

4. A method for establishing secure IP communications as defined in claim 3, wherein authorizing the at least first and second nodes into the virtual IP network further comprises validating the user account corresponding to each of the at least first and second nodes in the database of the at least one central server.

5. A method for establishing secure IP communication as defined in claim 3, wherein creating the user account comprises allocating a virtual user identification to each of the at least first and second nodes.

6. A method for establishing secure IP communication as defined in claim 5, wherein initiating a request for communication comprises sending a connection request containing the virtual user identification and a virtual IP address of the one of the at least first and second nodes initiating the request for communication, a virtual IP address of the other one of the at least first and second nodes and a type of requested service.

7. A method for establishing secure IP communication as defined in claim 1, wherein validating the request for communication comprises checking at least an access control list and an access blocking list in a database of the at least one central server.

8. A method for establishing secure IP communication as defined in claim 6, wherein validating the request for communication comprises checking the type of requested service in a service database of the at least one central server

9. A method for establishing secure IP communication as defined in claim 1, wherein granting at least one unique identifier comprises granting a unique virtual network connection ID for the requested communication.

10. A method for establishing secure IP communication as defined in claim 9, wherein granting the unique virtual network connection ID comprises granting a source virtual network connection ID to the one of the at least first and second nodes initiating the request for communication and a destination virtual network connection ID to the other of the at least first and second nodes.

11. A method for establishing secure IP communication as defined in claim 9, wherein granting at least one unique identifier comprises granting a virtual network connection stamp.

12. A method for establishing secure IP communication as defined in claim 11 wherein the virtual network connection stamp comprises a source virtual network connection ID, a destination virtual network connection ID, a connection request ID and a destination IP address.

13. A method for establishing secure IP communication as defined in claim 12, further comprising monitoring and auditing the communication through the virtual network connection stamp.

14. A method for establishing secure IP communication as defined in claim 1, wherein creating a secure channel comprises creating an encrypted peer to peer channel using a virtual IP messenger.

15. A method for establishing secure IP communication as defined in claim 1, wherein creating a secure channel comprises transmitting data between the at least first and second nodes using a virtual access control protocol.

16. A method for establishing secure IP communication as defined in claim 15, wherein transmitting the data between the at least first and second nodes using a virtual access control protocol comprises transmitting virtual access control protocol data packets.

17. A method for establishing secure IP communication as defined in claim 16, wherein transmitting the data between the at least first and second nodes comprises inserting the virtual network connection stamp into the virtual access control protocol data packets.

18. A method for establishing secure IP communication as defined in claim 17, wherein transmitting the data between the at least first and second nodes comprises encapsulating virtual IP data packets over virtual access control protocol data packets.

19. A method for establishing secure IP communication as defined in claim 17, further comprising validating the received virtual network connection stamp contained in the virtual access control protocol data packets by one of the at least first and second nodes which receives the virtual access control protocol data packets in collaboration with the at least one central server.

20. A method for establishing secure IP communication as defined in claim 17, further comprising forwarding the virtual access control protocol data packets to a virtual IP messenger proxy server.

21. A method for establishing secure IP communication as defined in claim 20, wherein forwarding the virtual access control protocol data packets to the virtual IP messenger proxy server comprising validating the virtual network connection stamp by the virtual IP messenger proxy server.

22. A system for establishing secure IP communication between at least first and second nodes through a virtual IP network managed by at least one central server, the system comprising:
means for initiating, from one of the at least first and second nodes, a request to the at least one central server for communication between the at least first and second nodes;
means for validating the request for communication between the at least first and second nodes;
means for granting at least one unique identifier to each of the at least first and second nodes upon successful validation; and
means for creating a secure channel for communication between the at least first and second nodes through the virtual IP network using their respective at least one unique identifier.

23. A system for establishing secure IP communication between at least first and second nodes through a virtual IP network, the system comprising:
an access manager for validating a request, initiated by one of the at least first and second nodes, for communication between the at least first and second nodes, the access manager further granting at least one unique identifier to each of the at least first and second nodes upon successful validation; and
a channel for providing the secure IP communication between the at least first and second nodes through the virtual IP network using their respective at least one unique identifier.

24. A system for establishing secure IP communication as defined in claim 23, further comprising an account manager for authorizing the at least first and second nodes into the virtual IP network.

25. A system for establishing secure IP communication as defined in claim 24, wherein the account manager comprises a user information database in which a registration profile is created and stored for each of the at least first and second nodes.

26. A system for establishing secure IP communication as defined in claim 24, wherein the account manager grants a virtual user identification to the at least first and second nodes upon successful authorization of the at least first and second nodes in the virtual IP network.

27. A system for establishing secure IP communication as defined in claim 23, wherein the access manager comprises at least an access control list, an access blocking list, and a service database associated to each of the at least first and second nodes, the at least access control list, access blocking list and service database are used for validating the request for communication.

28. A system for establishing secure IP communication as defined in claim 27, wherein the access manager grants at least one unique identifier to the requested communication.

29. A system for establishing secure IP communication as defined in claim 28, wherein the at least one unique identifier granted to the requested communication comprises a virtual network connection identification for the requested communication.

30. A system for establishing secure IP communication as defined in claim 29, wherein the virtual network connection identification comprises a source virtual network connection identification and a destination virtual network connection identification.

31. A system for establishing secure IP communication as defined in claim 30, wherein the access manager further grants a virtual network connection stamp for the requested communication.

32. A system for establishing secure IP communication as defined in claim 31, wherein the virtual network connection stamp comprises a source virtual network connection identification, a destination virtual network connection identification, a connection request ID and a destination IP address.

33. A system for establishing secure IP communication as defined in claim 23, further comprising a virtual IP messenger for establishing the channel for secure IP communication between the at least first and second nodes.

34. A system for establishing secure IP communication as defined in claim 33, wherein the channel comprises a secure peer to peer channel.

35. A system for establishing secure IP communication as defined in claim 33, wherein the channel uses a virtual access control protocol to exchange data packets between the at least first and second nodes.

36. A system for establishing secure IP communication as defined in claim 35, wherein the virtual access control protocol inserts the at least one unique identifier into a virtual access control protocol data packet.

37. A system for establishing secure IP communication as defined in claim 35, wherein the virtual access control protocol encapsulates virtual IP data packets into virtual access control protocol data packets.

38. A system for establishing secure IP communication as defined in claim 33, wherein the virtual IP messenger comprises a virtual IP messenger proxy server for forwarding data packets between the at least first and second nodes during the secure IP communication.

39. A system for establishing secure IP communication as defined in claim 38, wherein the virtual IP messenger validates a virtual network connection stamp for the communication.

40. A system for establishing secure IP communication as defined in claim 23, wherein the access manager comprises a plurality of virtual access managers for managing respective subsets of a virtual IP network.
